(19) United States
(12) Patent Application Publication
(10) Pub. No.: US 2007/0263289 A1
(43) Pub. Date: Nov. 15, 2007

(54) OPTICAL DEVICE AND COATING APPLICATOR

(75) Inventors: Hiroyuki MONOE, Niigata (JP); Kouzo YASUDA, Ibaraki (JP); Yukihiro YANAGAWA, Ibaraki (JP); Osamu KIMURA, Ibaraki (JP); Yoshio ABE, Niigata (JP); Katashi SAITO, Niigata (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KURARAY CO. LTD, Okayama (JP)

(21) Appl. No.: 11/829,136

(22) Filed: Jul. 27, 2007

Related U.S. Application Data
(63) Continuation-in-part of application No. PCT/JP06/01520, filed on Jan. 31, 2006.

(30) Foreign Application Priority Data
Jan. 31, 2005 (JP) 2005-024628
May 6, 2005 (JP) 2005-135338

(51) Int. Cl. G02B 5/02

(52) U.S. Cl. 359/599

(57) ABSTRACT

In a transmission type screen and other optical devices formed by combining optical sheets such as a Fresnel lens sheet and a lenticular lens sheet, the generation of stray light and defective appearance caused by a friction-reducing agent are prevented. In the optical devices such as a transmission type screen 3 formed by combining a plurality of optical sheets such as a Fresnel lens sheet 1 and a lenticular lens sheet 2, a friction-reducing agent 20 is provided on a surface of at least one of the optical sheets at a thickness of 0.3 nm or more to 10 nm or less. A coating applicator 30 for the friction-reducing agent 20 includes: a transfer roller 31; coating liquid-supplying means 32 for supplying the coating liquid 20 to the transfer roller 31; and scraping means 35 for adjusting the thickness of the coating liquid 20 adhering to the transfer roller 31. In the coating liquid 30, the surface roughness Ra (JIS B 0601-1982) of the transfer roller 31 is set to 0.01 to 1 μm.

This application is a Continuation-in-Part of application PCT/JP2006/301520 filed on Jan. 31, 2006, which claims the benefits of application JP2005-024628 filed Jan. 31, 2005 and application JP2005-135338 filed May 6, 2005. The entire disclosure of each of these prior applications is hereby incorporated by reference herein in its entirety.

### BACKGROUND OF THE INVENTION

1. Field of the Invention

The present invention relates to an optical device such as a transmission type screen for use in a rear projection type display device and the like, to a method for manufacturing the same, and to a coating applicator useful in the manufacturing method.

2. Description of the Related Art

Conventionally, in a rear projection type display device, a transmission type screen 3 is used which includes a Fresnel lens sheet 1 and a lenticular lens sheet 2 intimately contacting each other, as shown in FIG. 6.

Generally, the Fresnel lens sheet 1 is composed of a Fresnel lens having a plurality of concentric circular lens edges formed with a fine pitch. In the transmission type screen 3, this Fresnel lens is disposed on the light emitting face of the Fresnel lens sheet 1.

Meanwhile, the lenticular lens sheet 2 generally includes a plurality of cylindrical lenses disposed on both the light incident face and the light emitting face at regular intervals. Furthermore, in order to improve contrast in a bright room, on the light emitting face of the lenticular lens sheet 2, convex portions each having a surface with a light absorbing layer formed thereon are formed in regions on which light is not condensed through the cylindrical lenses on the light incident face. It should be noted that, in front of the light emitting side of the lenticular lens sheet 2, there may be disposed a protection sheet (not shown) formed of a glass plate or a resin plate which is planar and transparent.

As shown in FIG. 7, in a rear projection type display device 10, the transmission type screen 3 is attached to a frame 11, and the frame 11 is attached to a casing 12. An image light source 13 and a reflection mirror 14 are provided in the casing 12. Image light projected from the image light source 13 is reflected by the reflection mirror 14 and is enlarged and projected through the transmission type screen 3.

Meanwhile, the rear projection type display device 10 having the transmission type screen 3 attached thereto is transported by means of general transportation means such as railway or automobiles, and thus vibrations during transportation are transmitted to the transmission type screen 3. Therefore, the Fresnel lens sheet 1 and the lenticular lens sheet 2 rub against each other or collide with each other, and occasionally a part of the optical sheets is damaged. Thus, the optical sheets appear cloudy in appearance, or unevenness in brightness occurs when an image is displayed.

Therefore, a technique has been proposed in which, when the transmission type screen 3 is formed by bringing the Fresnel lens sheet 1 and the lenticular lens sheet 2 into intimate contact with each other, silicone oil serving as a friction-reducing agent is applied to the surface of the lenticular lens sheet 2 on the Fresnel lens sheet 1 side thereof at a coating thickness of several μm to prevent the damage caused by rubbing of the optical sheets against each other (Japanese Patent Application Laid-Open No. Sho 60-61738).

The problems caused by rubbing of the optical sheets against each other also occur in a back light optical device, which illuminates a LCD (liquid crystal display) panel from the back in a liquid crystal display device. Specifically, such a back light optical device is configured by combining any of optical sheets such as a light-diffusion sheet which has a randomly uneven surface, a light-diffusion sheet in which a light diffusion agent is dispersed, a microlens sheet, a prism sheet and the like, and is placed at the back of the LCD panel so that light emitted from a back light source may illuminate the LCD panel at even brightness. Accordingly, upon transportation of the liquid crystal display device, these optical sheets are rubbed against each other, and are rubbed against or knocked on a frame or pillar for supporting these optical sheets to damage part of these optical sheets, thereby in some cases resulting in unevenness in brightness of the back light optical device. Therefore a friction-reducing agent is applied to the surface of each or any of these optical sheets.

### SUMMARY OF THE INVENTION

However, when the technique proposed in Japanese Patent Application Laid-Open No. Sho 60-61738 is applied to the Fresnel lens sheet 1, a problem arises in that a region around the optical center thereof is remarkably bright when the transmission type screen 3 is viewed obliquely from above or below. Furthermore, when the technique proposed in Japanese Patent Application Laid-Open No. Sho 60-61738 is applied to the lenticular lens sheet 2, a problem arises in that vertical streak-like unevenness in brightness is noticeable when the transmission type screen 3 is viewed obliquely from the right or left side.

This is because a friction-reducing agent 20, such as silicone oil, applied to the lenticular lens sheet 2 is accumulated in a valley portion 2b of a row of lenses or prisms, as shown in, for example, FIG. 8, and the light incident on the valley portion 2b is refracted and reflected at the interface of the friction-reducing agent 20 and is emitted in directions not originally intended so that stray light is generated.

In a case in which a transmission type screen is formed by facing the flat surface of one of optical sheets and the lens surface of the other optical sheet toward each other and bringing them into contact with each other, a similar problem may arise when a friction-reducing agent is applied to the flat surface of the one optical sheet. Specifically, the friction-reducing agent is transferred to the lens surface of the other optical sheet and is accumulated in the valley portions of a row of lenses.

The influence of the friction-reducing agent accumulated in the valley portions of the lenses increases as the pitch of the lenses decreases. Therefore, in recent years where the pitch of lens sheets tends to decrease in order to achieve high definition or the like, the necessity to reduce adverse effects of a friction-reducing agent on a transmission type screen has increased.

Furthermore, in the manufacturing step or the transportation step of transmission type screens, they are loaded and packed with a cushion material (such as a poly-laminated paper sheet, a foamed polyethylene sheet, or the like) between optical sheets to which a friction-reducing agent is applied. However, in this case, patterns such as wrinkles occurring in the cushion material are transferred to the optical sheets, causing a problem of defective appearance. Similar defective appearance does not occur in optical sheets to which a friction-reducing agent is not applied, and the extent of the defective appearance is reduced when the friction-reducing agent-applied surface having had the defective appearance is wiped with a cloth or the like. For these and other reasons, it is considered that the above problem occurs because the wrinkles occurring in the cushion material are transferred to the friction-reducing agent on the optical sheets.

The present invention aims to solve the above conventional problems. It is an object of the invention to prevent, in a transmission type screen or other optical devices formed by combining optical sheets such as a Fresnel lens sheet, a lenticular lens sheet, a prism sheet, a microlens, a light-diffusion sheet and the like, the generation of stray light and defective appearance caused by a friction-reducing agent. It is another object of the invention to provide a coating applicator which, when a coating liquid such as a friction-reducing agent is applied to various optical sheets including a Fresnel lens sheet, a lenticular lens sheet and other optical sheets constituting a transmission type screen or other optical devises, is capable of applying the coating liquid such that the generation of stray light and defective appearance caused by the coating liquid can be prevented.

Conventionally, it has been considered that, in a transmission type screen or other optical devices having a plurality of optical sheets combined together, the extent of the damage caused by rubbing and colliding of the optical sheets against each other can be reduced by increasing the amount of a friction-reducing agent applied between the optical sheets, and accordingly a friction-reducing agent has been applied to the surface of the optical sheets at a thickness of several μm. However, the present inventors have found that the damage of optical sheets can be prevented even when the coating amount of a friction-reducing agent is significantly reduced as compared to the amount conventionally used, and that the problem of stray light and defective appearance can be resolved by setting the coating thickness of the friction-reducing agent within a specific range. Furthermore, the inventors have found that, as a coating applicator for the friction-reducing agent used in the above case, a coating applicator is effective which employs a transfer roller and in which the surface roughness of the transfer roller is set within a specific range.

Accordingly, the present invention provides an optical device including a combination of a plurality of optical sheets, wherein a friction-reducing agent is provided on a surface of at least one of the optical sheets to a thickness of 0.3 nm or more and 10 nm or less.

Furthermore, the present invention provides a method for manufacturing the abovementioned optical device, comprising applying a friction-reducing agent to at least one surface of the plurality of optical sheets constituting the transmission type screen at a thickness of 0.3 nm or more and 10 nm or less.

Moreover, the present invention provides a coating applicator having: a transfer roller; coating liquid-supplying means for supplying a coating liquid to the transfer roller; and scraping means for adjusting a thickness of the coating liquid adhering to the transfer roller, wherein a surface roughness Ra (JIS B 0601-1982) of the transfer roller is 0.01 to 1 μm.

In the optical device of the present invention, the thickness of the friction-reducing agent on the surface of the optical sheet is very small, i.e., 0.3 nm or more and 10 nm or less, and therefore the friction-reducing agent is less likely to be accumulated in valley portions of unit lenses, prisms or randomly uneven surface of the optical sheet. Hence, a projected light beam is prevented from being refracted and reflected in directions not originally intended, whereby stray light is less likely to be generated. Therefore, in a rear projection type display device to which the transmission type screen as the optical device of the present invention is mounted, a high quality image without the stray light phenomenon can be displayed. In addition, since the friction-reducing agent is less likely to be accumulated in valley portions as mentioned above, light to be evenly diffused is not to be unevenly diffused. Therefore in a liquid crystal display device to which the back light optical device as the optical device of the present invention is mounted, light which illuminates the LCD panel from the back surface thereof has even brightness, a high quality image without unintended uneven brightness can be obtained.

Furthermore, since the thickness of the friction-reducing agent on the surface of the optical sheet is very small, wrinkles in a cushion material or the like contacting the optical sheet are less likely to be transferred to this optical sheet. Therefore, in the optical device of the present invention, when the optical sheets are loaded and packed using a cushion material in the manufacturing step of the screen, the appearance is well maintained.

Meanwhile, in the coating applicator of the present invention, the surface roughness of the transfer roller is 0.01 to 1 μm and thus is adjusted substantially to that of a mirror surface. Therefore, by using this coating applicator, the coating liquid can be applied to an optical sheet at a very small thickness of, for example, 0.3 to 100 nm.

Hence, when a friction-reducing agent, for example, is applied to an optical sheet by means of this applicator, a very thin coating of the friction-reducing agent having a thickness of 0.3 nm or more and 10 nm or less can be formed on the optical sheet, whereby the optical device of the present invention can be manufactured.

### BRIEF DESCRIPTION OF THE DRAWINGS

FIG. 1 is a schematic cross sectional view of an embodiment of the present invention.

FIG. 2 is a schematic configuration diagram of a coating applicator.

FIG. 3 is a development view of the circumferential surface of a transfer roller, illustrating the fact that the surface roughness varies depending on the position on the transfer roller.

FIG. 4A is an illustrative view of a state in which a coating roller comes into contact with the lens surface of a lenticular lens sheet.

FIG. 4B is an illustrative view of a state in which the coating roller comes into contact with the lens surface of a Fresnel lens sheet.

FIG. 5A is an illustrative view of the profile of a friction-reducing agent applied to the lenticular lens sheet by means of the coating applicator.

FIG. 5B is an illustrative view of the profile of the friction-reducing agent applied to the lenticular lens sheet by means of the coating applicator.

FIG. 5C is an illustrative view of the profile of the friction-reducing agent applied to the lenticular lens sheet by means of the coating applicator.

FIG. 6 is a schematic cross sectional view of a general projection type screen.

FIG. 7 is a schematic configuration diagram of a rear projection type display device.

FIG. 8 is an illustrative view showing a problem in a conventional lenticular lens sheet on which a friction-reducing agent is provided.

### DETAILED DESCRIPTION OF THE PREFERRED EMBODIMENTS

Hereinafter, the present invention will be described in detail with reference to the drawings. In the drawings, the same reference numerals designate the same or similar components.

In the present invention, the coating thickness of a coating liquid is defined as a value obtained by dividing the volume of the coating applicator applied to a unit area (the value obtained by dividing the coating weight by the specific gravity) by a unit area. When the coating liquid contains a volatile organic solvent, the coating thickness just after the coating may be different from that after the solvent is volatilized and the coating liquid is dried. In this case, the coating thickness refers to the thickness just after the coating.

FIG. 1 is a schematic cross sectional view of a transmission type screen 3A of an embodiment of the optical device of the present invention. In this transmission type screen 3A, the emitting surface of a Fresnel lens sheet 1 is opposed to the incident surface of a lenticular lens sheet 2, and a friction-reducing agent 20 is provided on the incident surface 2a of the lenticular lens sheet 2.

Various agents having a friction reducing effect may be employed as the friction-reducing agent 20. Of these, silicone oil is preferable in terms of transparency, the friction reducing effect, environmental stability, and the like. More specifically, dimethyl silicone oil called “dimethyl polysiloxane” as a generic name, methylphenyl silicone oil, methyl hydrogen silicone oil, and the like are preferable. In addition, modified silicone oils such as polyether-modified silicone oils, methylstyryl-modified silicone oils, alkyl-modified silicone oils, higher fatty acid ester-modified silicone oils, and fluorine-modified silicone oils may be employed. Furthermore, chlorosilane-based oils, alkoxysilane-based oils, fluorine-based oil called “chlorotrifluoroethylene” as a generic name, and the like may be employed.

The kinematic viscosity of the friction-reducing agent 20 at 25° C. is preferably 100 to 1000 mm²/S (JIS K 2283) and more preferably 200 to 500 mm²/S.

This transmission type screen 3A is characterized in that the thickness of the friction-reducing agent 20 is very small, i.e., 0.3 nm or more and 10 nm or less. By setting the thickness of the friction-reducing agent 20 to 10 nm or less, the accumulation of the friction-reducing agent 20 in valley portions of a row of lenses of the lenticular lens sheet 2 can be effectively prevented. Therefore, the generation of stray light generated when a light beam incident on a valley portion is refracted and reflected at the interface of the friction-reducing agent 20 and is emitted in directions not originally intended can be prevented. In addition, in the manufacturing step or the transportation step of the transmission type screen 3A, the friction-reducing agent 20 is prevented from transferring from the lenticular lens sheet 2 to the Fresnel lens sheet 1 and from being accumulated in valley portions of a row of prisms of the Fresnel lens sheet 1, whereby the generation of stray light can be similarly prevented.

Furthermore, when the lenticular lens sheets 2 are loaded and packed using a packaging material such as a cushion material, wrinkles or the like in the packaging material are less likely to be transferred to the friction-reducing agent 20 on the surface of the lenticular lens sheet 2, and thus the occurrence of defective appearance associated with the transfer of the wrinkles can be prevented.

Meanwhile, by setting the thickness of the friction-reducing agent 20 to 0.3 nm or more, a problem of damage and the like of lenses caused by rubbing and colliding of the lenticular lens sheet 2 with the Fresnel lens sheet 1 can be effectively resolved. Furthermore, when the friction-reducing agent 20 is allowed to adhere to the lenticular lens sheet 2 through the wettability thereof, it is difficult to set the coating thickness of the friction-reducing agent 20 to less than 0.3 nm. This may be because the value 0.3 nm is the minimum coating thickness due to the size of one molecule of the friction-reducing agent 20.

A preferred thickness of the friction-reducing agent 20 depends on the configuration of sheets of the transmission type screen, the type of the friction-reducing agent used, and the like. For example, when the abovementioned friction-reducing agent 20 is employed on the lenticular lens sheet 2 in the sheet configuration of FIG. 1, the thickness of the friction-reducing agent 20 is normally preferably 0.5 nm or more and 6 nm or less and more preferably 1 nm or more and 5 nm or less.

FIG. 1 shows an example in which the friction-reducing agent 20 is applied to the incident surface 2a of the lenticular lens sheet 2. However, in the transmission type screen of the present invention, the friction-reducing agent may be applied to the Fresnel lens sheet 1 or may be applied to another optical sheet constituting the transmission type screen. Also in these cases, the coating thickness of the friction-reducing agent on each sheet surface is 0.3 nm or more and 10 nm or less, preferably 0.5 nm or more and 6 nm or less, and more preferably 1 nm or more and 5 nm or less.

In the case where the coating thickness of the friction-reducing agent 20 of the present invention is applied to the Fresnel lens sheet 1, a Fresnel lens sheet with a lens pitch of 0.2 mm or less and a lens edge height of 100 μm or less is preferable as the Fresnel lens sheet 1. In the Fresnel lens sheet 1, a particularly preferable pitch is 0.15 mm or less, and a still more preferable pitch is 0.1 mm or less. This is because the effect of the friction-reducing agent accumulated in the lens valley portions increases as the pitch of the lenses decreases, so that the effect of the present invention becomes remarkable.

Meanwhile, in the case where the coating thickness of the friction-reducing agent 20 of the present invention is applied to the lenticular lens sheet 2 as described above, a lenticular lens sheet with a lens pitch of 0.7 mm or less and a lens edge height of 700 μm or less is preferable as the lenticular lens sheet 2. Also in the lenticular lens sheet, the effect of the friction-reducing agent accumulated in the lens valley portions increases as the pitch of the lenses decreases, so that the effect of the present invention becomes remarkable. Thus, in the lenticular lens sheet, a particularly preferable pitch is 0.5 mm or less, and a still more preferable pitch is 0.3 mm or less.

Furthermore, when the friction-reducing agent 20 is applied to the Fresnel lens sheet 1, it is more preferable that the coating thickness be larger in a region other than the central region of the Fresnel lens sheet 1 (in particular, the peripheral region) than in the central region including the optical center of the Fresnel lens. For example, when the coating thickness in the central region of the Fresnel lens sheet 1 is 0.3 to 3 nm, the coating thickness in the peripheral region is set to 3 to 10 nm.

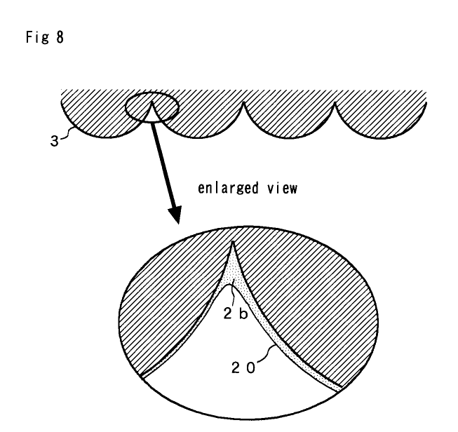

This is because of the following and other reasons. In the Fresnel lens, the edge portions thereof in the peripheral region are sharper and higher. Furthermore, as shown in FIG. 7, the circumferential edge portion of the transmission type screen 3 is secured through the frame 11. Thus, in the peripheral region of the Fresnel lens sheet 1, the contact pressure with the lenticular lens sheet 2 is higher and thus is more likely to cause damage. Therefore, in the peripheral region, it is preferable to increase the coating thickness of the friction-reducing agent 20. On the other hand, at the optical center of the Fresnel lens, the height of the lens edge is lower, and the influence of the friction-reducing agent 20 is particularly larger. Therefore, at the optical center, it is preferable to reduce the coating thickness of the friction-reducing agent in order to suppress the accumulation of the friction-reducing agent 20 in the lens valley portions 2b.

Here, the central region of the Fresnel lens sheet 1 means, in the case of, for example, a Fresnel lens sheet with a diagonal distance of 40 to 70 inches, a generally circular region with the center at the optical center of the Fresnel lens and with a diameter of 50 mm or less, more preferably 25 mm or less, and particularly preferably 10 mm or less. When the friction-reducing agent is applied to the Fresnel lens sheet 1 by means of a conventional method, stray light is observed in the central region of the Fresnel lens sheet 1. However, according to the present invention, the generation of stray light in the central region of the Fresnel lens sheet 1 can be prevented.

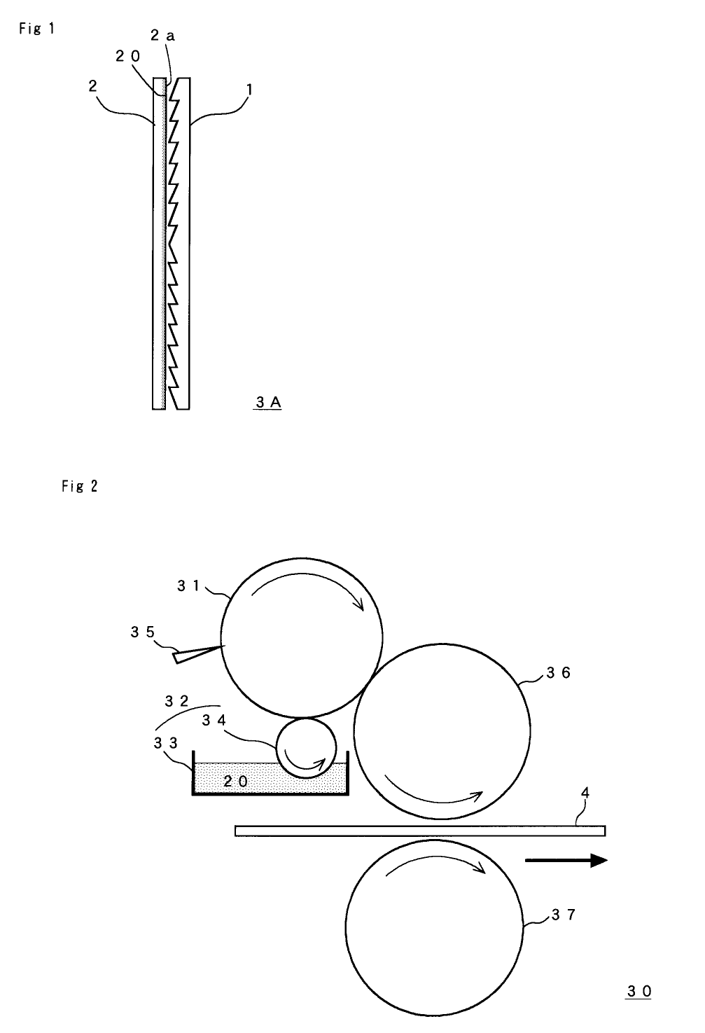

Examples of the specific method for applying the friction-reducing agent include: a method in which the friction-reducing agent is added to absorbent cotton and then is applied by means of hand or a coating tool such as a roller; and a coating method by means of a roller transfer apparatus. In particular, in terms of uniformity of the coating amount, ease of adjusting the coating amount, and the like, a roller transfer type coating applicator 30 shown in FIG. 2, for example, is preferably used.

FIG. 2 is a schematic configuration diagram of the coating applicator 30, which is one embodiment of the coating applicator of the present invention. The coating applicator 30 of FIG. 2 is an applicator for applying a coating liquid 20 such as a friction-reducing agent, an antistatic agent, an anti-reflection agent, or an anti-glare agent to an optical sheet 4 such as a Fresnel lens sheet, a lenticular lens sheet, a prism sheet, a diffraction grating sheet, a microlens sheet or a diffusion sheet. The coating applicator 30 includes: a transfer roller 31; coating liquid-supplying means 32 for supplying the coating liquid 20 to the transfer roller 31; scraping means 35 for adjusting the thickness of the coating liquid 20 adhering to the transfer roller 31; and conveying means (not shown) for the optical sheet.

The coating liquid-supplying means 32 includes: a coating liquid bath 33 into which the friction-reducing agent 20 is filled; and a supply roller 34 which supplies the coating liquid 20 from the coating liquid bath 33 to the transfer roller 31.

The scraping means 35 includes a doctor blade. Furthermore, in the coating applicator 30 of the present invention, the scraping means 35 may be provided with a doctor roller, a roller knife, and the like.

Furthermore, this coating applicator 30 includes: a rubber-made coating roller 36 which transfers the coating liquid 20 from the transfer roller 31 to the optical sheet 4; and a backup roller 37 which presses the optical sheet 4 against the coating roller 36. In the coating liquid of the present invention, this coating roller 36 is provided in accordance with need. Therefore, when the coating roller 36 is omitted, the transfer roller 31 is brought into direct contact with a object to be coated, whereby the coating liquid 20 can be applied to the object. However, when the object is hard or when the thickness thereof varies along the width direction, it is preferable to provide the coating roller 36 as shown in FIG. 2. Specifically, in the case where the optical sheet 4 is hard, the direct contact between the optical sheet 4 and the transfer roller 31 may cause the optical sheet 4 or the transfer roller 31 to be damaged. Furthermore, in the case where the thickness of the optical sheet 4 varies along the width direction, when the optical sheet 4 and the transfer roller 31 are brought into direct contact with each other, the contact pressure in thick portions may be different from that in thin portions, and thus unevenness of coating may occur. Thus, in such cases, it is preferable to provide the coating roller 36 as described above.

The transfer roller 31 is formed of a metal such as stainless steel, a material obtained by subjecting such a metal to plating treatment such as chromium plating, an elastomer such as rubber, a plastic such as an epoxy resin, a ceramic such as alumina, or the like. Only the surface of the transfer roller 31 may be formed of a different material. The coating applicator of the present invention is characterized in that the surface roughness Ra (JIS B 0601-1982) of the transfer roller 31 is 0.01 to 1 μm. By setting the surface roughness of the transfer roller 31 within the above range and scraping the excess coating liquid 20 on the transfer roller 31 with the scraping means 35 such as a doctor blade, the amount of the coating liquid 20 on the transfer roller 31 can be adjusted to a very small amount.

Specifically, the surface of the transfer roller 31 is a substantially mirror surface with a surface roughness of 0.01 to 1 μm. Thus, when the surface of the transfer roller 31 is scraped by the scraping means 35 such as a doctor blade, it is presumed that the coating liquid 20 is no longer present on the surface of the transfer roller 31. However, when the coating liquid 20 is, for example, a silicone oil-based friction-reducing agent, the coating liquid 20 exhibits high compatibility with the above metal, plastic, or ceramic serving as the surface material of the transfer roller 31. Accordingly, even when the coating liquid 20 is scraped with the scraping means 35, a very small amount of the coating liquid 20 remains present on the transfer roller 31. Then, by bringing such coating liquid 20 into contact with the optical sheet 4, or preferably by bringing such coating liquid 20 into contact with the optical sheet 4 through the coating roller 36, the compatibility between the coating liquid 20 and the optical sheet 4 allows the coating liquid 20 to be transferred to the optical sheet 4 at a thickness of 0.3 nm to 100 nm, particularly 0.3 nm to 10 nm, which is much smaller than a conventional thickness. The coating method by means of the transfer roller 31 having the abovementioned surface roughness utilizes fine asperities on the surface of the transfer roller 31 and may be regarded as a type of gravure printing.

The surface roughness of the transfer roller 31 may be changed depending on the position on the transfer roller 31. For example, by reducing the roughness in the central portion of the transfer roller 31 and increasing the roughness in the outer peripheral portion, the coating thickness in the central portion of the optical sheet 4 can be made small, and the coating thickness in the outer peripheral portion can be made large.

Hence, by changing the surface roughness depending on the position on the transfer roller 31, the coating thickness on the optical sheet 4 can be changed according to the susceptibility to damage caused by rubbing. Specifically, the damage in the optical sheet 4 does not always occur uniformly over the sheet surface but rather tends to occur at specific positions. For example, when pressure is applied locally to a screen during securing the screen to a frame, damage is likely to occur near the frame. Furthermore, when screens vibrate sympathetically with vibration from the outside, the impact of the collision between the screens is large at positions corresponding to the antinode of the amplitude, and thus damage is likely to occur at such positions. In a Fresnel lens sheet, the heights of the unit lenses are different in the sheet surface. In this case, the susceptibility to damage depends on the height of the lens. In view of this, by changing the surface roughness depending on the position on the transfer roller 31, the coating amount can be set according to the susceptibility to damage.

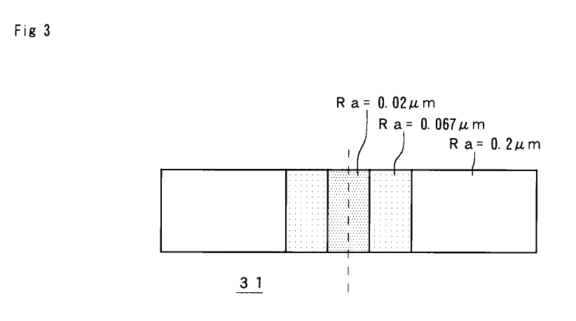

When the surface roughness of the transfer roller 31 is changed depending on the position on the transfer roller 31, it is preferable to change the surface roughness stepwise or continuously as shown in, for example, FIG. 3. In this manner, the occurrence of unevenness of coating and defective appearance can be prevented at a boundary position where the coating amount changes.

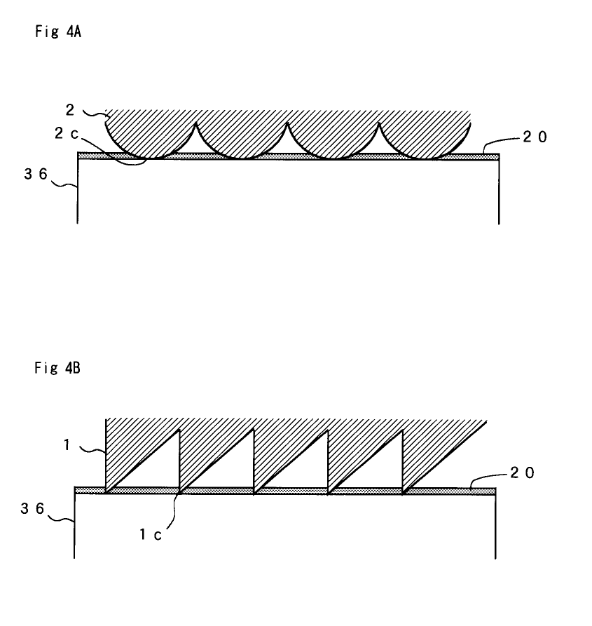

In the coating applicator 30, it is preferable to properly change the specific value of the surface roughness of the transfer roller 31 within the above range according to the type of the optical sheet 4 (for example, a lenticular lens sheet or a Fresnel lens sheet), the surface geometry of the coating surface (for example, a lens surface or flat surface), the type of the coating liquid 20, and the like. For example, as shown in FIG. 4A, when the coating liquid 20 is applied to the lens surface of the lenticular lens sheet 2, a top portion 2c of each cylindrical lens having a semi-circular cross-section comes into linear contact with the coating liquid 20 on the coating roller 36. However, as shown in FIG. 4B, when the coating liquid 20 is applied to the lens surface of the Fresnel lens sheet 1, a top portion 1c of a polygonal cross-section comes into contact with the coating liquid 20 on the coating roller 36. Therefore, even when the surface roughness of the transfer roller 31 is the same in the cases of the lens surface of the lenticular lens sheet 2 and the lens surface of the Fresnel lens sheet 1, a larger amount of the coating liquid 20 is applied to the lens surface of the lenticular lens sheet 2. Hence, when the lens surface of the lenticular lens sheet 2 is an object to be coated, the surface roughness of the transfer roller 31 is normally preferably within the range of 0.01 to 0.5 μm. In particular, when the pitch of the lenticular lens sheet 2 is 0.3 mm or less, the surface roughness of the transfer roller 31 is more preferably within the range of 0.01 to 0.2 μm. Meanwhile, when the lens surface of the Fresnel lens sheet 1 is an object to be coated, the surface roughness of the transfer roller 31 is preferably 0.01 to 1 μm. Particularly, when the pitch of the Fresnel lens sheet 2 is 0.1 mm or less, the surface roughness of the transfer roller 31 is more preferably 0.01 to 0.5 μm.

Furthermore, it is unnecessary to reduce the surface roughness of the transfer roller 31 to less than 0.01 μm. When the surface roughness is reduced to less than 0.01 μm, unevenness of coating due to flaws and the like is rather noticeable. In addition, even when the surface roughness is reduced to less that 0.01 μm, the reduction of the surface roughness does not result in a reduction of the coating thickness. For example, in the case where a silicone oil-based friction-reducing agent is applied, the coating thickness cannot be reduced to less than 0.3 nm. This may be because a state in which a monomolecular film of the silicone oil-based friction-reducing agent adheres to the transfer roller 31 gives a minimum coating thickness, and the thickness of the monomolecular film is 0.3 nm.

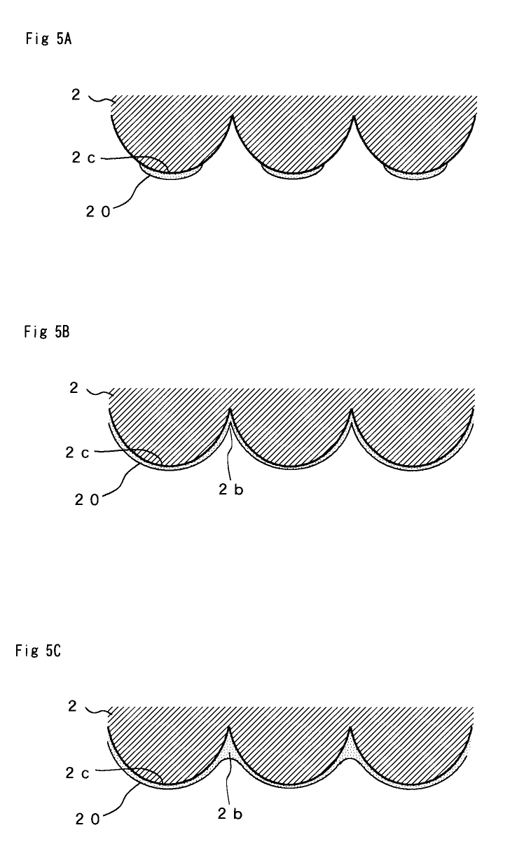

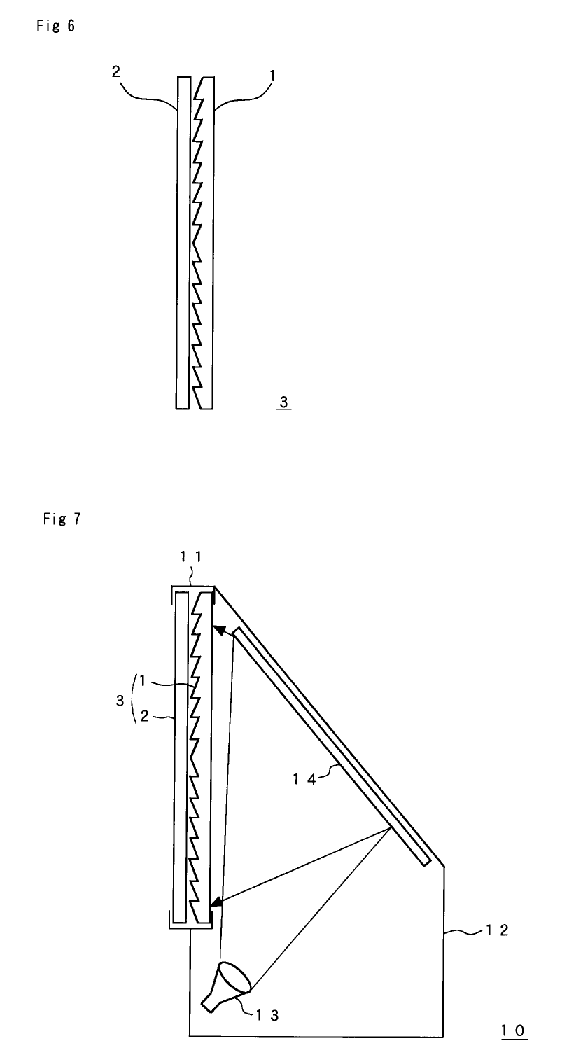

The coating liquid 20 thickness which can be applied by means of the coating applicator 30 also depends on the surface geometry of the optical sheet 4. When the coating surface of the optical sheet 4 has an irregular geometry, a thinner coating can be formed as compared to a case where the coating surface is flat. This is described with reference to FIGS. 5A to 5C.

FIGS. 5A to 5C are illustrative views of a profile of the coating liquid 20 when a silicone oil-based friction-reducing agent serving as the coating liquid 20 is applied to the surface of the lenticular lens sheet 2 at different thicknesses by means of the above coating applicator 30.

First, the apex of each of the lenses of the lenticular lens sheet 2 comes into contact with the coating roller 36 of the coating applicator 30, whereby the friction-reducing agent 20 adhering to the surface of the coating roller 36 adheres to at least around the apex of each of the lenses. At this time, when the adhering amount of the friction-reducing agent 20 is relatively small, the friction-reducing agent 20 is stabilized in a state in which the coating liquid 20 adheres to only the top portion 2c of each of the lenses, as shown in FIG. 5A. Therefore, a thinner coating can be obtained in the case in which the friction-reducing agent 20 is applied to a surface having asperities than in the case in which the friction-reducing agent 20 is applied to a flat coating surface.

When the adhering amount is larger than that in the state of FIG. 5A, the coating liquid 20 is stabilized in a state in which the coating liquid 20 adheres to the entire surface of each of the lenses as shown in FIG. 5B. In this case, the coating liquid 20 adheres also to the lens valley portions 2b. However, in the transmission type screen of the present invention, since the coating thickness of the coating liquid (friction-reducing agent) 20 is 10 nm or less, the adhering amount of the coating liquid 20 adhering to the lens valley portions 2b is not as large as the amount which causes optical problems such as the generation of stray light.

Meanwhile, when the coating thickness of the coating liquid 20 exceeds 10 nm, the coating liquid 20 is accumulated so as to fill the lens valley portions 2b, as shown in FIG. 5C. In this state, a problem arises in that stray light is generated when an image light source incident on the lens valley portions 2b is refracted and reflected in directions not originally intended, and unevenness in contrast occurs when the transmission type screen is viewed obliquely.

Furthermore, depending on the surface geometry of an optical sheet, the friction-reducing agent 20 is accumulated in the lens valley portions 2b when the coating thickness exceeds 100 nm, whereby optical problems arise. Therefore, in the coating applicator 30 of the present invention, the friction-reducing agent 20 is allowed to be applied up to a coating thickness of 100 nm.

In this coating applicator 30, it is preferable that the rotation speed of the transfer roller 31 or the coating roller 36 be adjustable. By adjusting the rotation speeds of the transfer roller 31 and the coating roller 36, the relative speed (linear speed) between the transfer roller 31 and the coating roller 36 can be changed, whereby the coating amount on the optical sheet 4 can be adjusted.

Furthermore, in this coating applicator 30, it is preferable that the relative speed between the transfer roller 31 or the coating roller 36 and the optical sheet 4 be adjustable. The coating amount on the optical sheet 4 can be also adjusted by changing the above relative speed.

Moreover, in the coating applicator 30, it is preferable that the conveying means for the optical sheet 4 be configured such that the coating can be repeated on the optical sheet 4 in a plurality of directions. By repeating the coating in a plurality of directions, unevenness of coating generated on the optical sheet at the first coating can be reduced.

In particular, when the coating amount on the surface of the optical sheet 4 is changed by use of the transfer roller 31 having non-uniform surface roughness as shown in FIG. 3, the distribution pattern of the coating thickness exhibits a band-like form after the first coating. However, by repeating the coating in a plurality of directions, the coating thickness can be adjusted for specific positions. Specifically, for example, the coating thickness can be more increased in the peripheral portion of the optical sheet 4 than in the central portion, or the coating thickness can be more reduced in the central portion of the Fresnel lens than in the peripheral portion.

Furthermore, a friction-reducing agent having a kinematic viscosity (JIS K 2283, at 25° C.) of 100 to 1000 mm²/s is preferred as the friction-reducing agent employed for the transmission type screen of the present invention, as described above. Furthermore, the coating liquid 20 which can be used in the coating applicator 30 of the present invention has a kinematic viscosity (JIS K 2283, at 25° C.) of preferably 30 to 3000 mm²/s, more preferably 100 to 1000 mm²/s, and particularly preferably 200 to 500 mm²/s, in terms of the ease of handling and of effectively providing the feature of the applicator in which the surface roughness of the transfer roller 31 is very small. When the kinematic viscosity is too large, the coating liquid 20 may not be scraped to a sufficiently small thickness when the surface of the transfer roller 31 is scraped with a doctor blade or the like. On the contrary, when the kinematic viscosity is too low, for example, the coating liquid on the roller may be distributed unevenly due to the gravity, and thus a handling problem may arise. In particular, in the case of a friction-reducing agent containing a volatile solvent and prepared to have a low kinematic viscosity, the friction-reducing effect may vary with time.

Furthermore, examples of the coating liquid 20 used in this coating applicator 30 include, in addition to the above-described coating liquid, an antistatic agent, anti-reflection agent, and an anti-glare agent.

Moreover, examples of the optical sheet 4 to which the coating liquid 20 is suitably applied by means of this coating applicator 30 include a Fresnel lens sheet with a diagonal distance of 40 to 70 inches, a lens pitch of 0.04 to 0.2 mm, and a maximum lens edge height of 40 to 100 μm. Furthermore, examples of the lenticular lens sheet include a lenticular lens sheet with a diagonal distance of 40 to 70 inches, a lens pitch of 0.05 to 1 mm, and a maximum lens height of 10 to 100 μm. In particular, the influence of the coating liquid 20 accumulated in the lens valley portions increases as the lens pitch decreases. Therefore, the effect of this coating applicator becomes remarkable as the lens pitch decreases. In the Fresnel lens sheet, the pitch is particularly preferably 0.15 mm or less and still more preferably 0.1 mm or less. In the lenticular lens sheet, the pitch is particularly preferably 0.7 mm or less and still more preferably 0.5 mm or less.

As above, based on the transmission type screen 3A having the sheet configuration shown in FIG. 1, a description has been given of the transmission type screen as the optical device of the present invention and the coating applicator useful for applying a friction-reducing agent to an optical sheet constituting the transmission type screen. However, the optical device of the present invention may take various different forms.

For example, in place of or in addition to the Fresnel lens sheet 1 or the lenticular lens sheet 2, a prism sheet, a microlens sheet, a light-diffusion sheet which has a randomly uneven surface, a light-diffusion sheet in which a diffusion agent is dispersed, and the like may be used as the optical sheet constituting the transmission type screen.

The optical device of the present invention can be applied to a back light optical device in liquid crystal display device, where such a back light optical device is configured by properly combining or laminating any of those optical sheets.

Furthermore, no particular limitation is imposed on the coating surface of the optical sheets constituting the optical device, i.e., the friction-reducing agent may be applied to one or a plurality of the surfaces of the optical sheets.

The optical device of the present invention can be used similarly to the conventional optical devices. For example, the transmission type screen of the present invention can be preferably used as a transmission type screen in a conventional rear projection type display device, and the back light optical devices can be preferably used as a back light optical device in a conventional liquid crystal display device.

### EXAMPLES

Hereinafter, the present invention will now be described in detail by way of examples.

### Test Example 1

First, a methyl methacrylate-styrene copolymer was employed as a main raw material, and a lenticular lens sheet (lens pitch: 0.15 mm, maximum lens height: 50 μm) was produced by means of extrusion molding.

Furthermore, in addition to the lenticular lens sheet, a methyl methacrylate-styrene copolymer was extrusion molded on the surface of a substrate for a Fresnel lens, and a Fresnel lens shape made of an ultraviolet curable resin containing urethane acrylate was imparted to the surface of the substrate by means of a mold, whereby a Fresnel lens sheet (lens pitch: 0.07 mm, maximum lens height: 70 μm) was separately produced.

Thereafter, by means of the coating applicator 30 shown in FIG. 2, silicone oil (Silicone oil KF96, product of Shin-Etsu Chemical Co., Ltd.) serving as the coating liquid 20 was applied to the surface on the lens side of the Fresnel lens sheet as follows. First, the supply roller 34 having a roller surface formed of synthetic rubber was rotated and brought into contact with the silicone oil in the coating liquid bath 33, whereby the silicone oil was supplied to the metal-made transfer roller 31. The thickness of the silicone oil on the transfer roller 31 was adjusted by a doctor blade 35, and the silicone oil layer having an adjusted thickness was transferred to the surface of the rubber-made coating roller 36 and then was transferred to the Fresnel lens sheet which was pressed against the coating roller 36 by the backup roller 37.

In this case, the surface roughness Ra of the transfer roller 31 was changed from 0.02 μm to 2.0 μm as shown in Table 1, and the same procedure was repeated. For each of the cases, the speed of each of the transfer roller 31 and the coating roller 36 was 10 m/min.

Then, each of the Fresnel lens sheets to which the silicone oil was applied was combined with the lenticular lens sheet described above, thereby producing a transmission type screen.

### Test Example 2

The same procedure as in Test Example 1 was repeated except that the silicone oil was not applied to the Fresnel lens sheet and that the silicone oil was applied to the lens surface of the lenticular lens sheet with the surface roughness Ra of the transfer roller 31 changed from 0.02 μm to 2.0 μm as shown in Table 1, thereby producing transmission type screens.

Evaluation

(1) Measurement of the Coating Thickness of the Silicone Oil

The Fresnel lens sheets or the lenticular lens sheets to which the silicone oil was applied in each of the Test Examples were measured for coating thickness just after the coating of the silicone oil as follows.

First, a reference solution was prepared in advance by mixing 0.01 g of the silicone oil with 5 mL of chloroform deuteride. Next, the reference solution was evaluated by means of nuclear magnetic resonance spectroscopy (H-NMR method). Specifically, the peak intensity m of the methyl group of the silicone oil (the integrated intensity of the peak at 0.071 ppm) and the peak intensity c of non deuterium-substituted chloroform in the chloroform deuteride (the integrated intensity of the peak at 7.24 ppm) were measured. Then, the intensity ratio 1 between the peak intensity m and the peak intensity c was calculated. The peak intensity ratio 1 was used as a reference indicating that the weight of the silicone oil in 5 mL of the chloroform deuteride was 0.01

Similarly, five different reference solutions each having the weight of the silicone oil within the range of 0.01 to 0.1 g were prepared and evaluated, whereby peak intensity ratios 1 to 5 were obtained in advance.

Next, each of the Fresnel lens sheets or the lenticular lens sheets to which the silicone oil was applied was cut into a size of 300 mm×300 mm. The silicone oil-applied surface of the cut sheet washed with 200 mL of a hexane solution. Then, the hexane solution was removed, and thus only the silicone oil was allowed to remain on applied surface. Then, 5 mL of chloroform deuteride was mixed with the above silicone oil, and the peak intensity ratio A between the methyl group in the silicone oil in the mixture and non deuterium-substituted chloroform in the chloroform deuteride was evaluated by means of the H-NMR method.

Subsequently, the obtained peak intensity ratio A was compared with the peak intensity ratios 1 to 5 of the reference solutions evaluated in advance, whereby the weight of the silicone oil in each of the lens sheets was determined. Next, the measured weight of the silicone oil was divided by the specific gravity of the silicone oil and divided by the area of the lens sheet (300 mm×300 mm), thereby obtaining the coating thickness of the silicone oil.

Here, the amount of the silicone oil contained in each of the reference solutions was increased or decreased according to the coating amount of the silicone oil. Moreover, when the coating thickness of the silicone oil was not uniform on the entire surface of each of the lens sheets, the above cutting size was appropriately changed, and similar measurement was performed.

The results are shown in Table 1.

TABLE 1

| | | | | Coating |
|---|---|---|---|---|
| | | Coating | Surface roughness | thickness |
| | | surface of | Ra of transfer | of silicone |
| | | silicone oil | roller (μm) | oil (nm) |
| Test Example 1 | (1) | Fresnel | 0.02 | 0.3 |
| | (2) | lens sheet | 0.04 | 1 |
| | (3) | | 0.2 | 10 |
| | (4) | | 0.3 | 20 |
| | (5) | | 1.0 | 100 |
| | (6) | | 2.0 | 200 |
| Test Example 2 | (1) | Lenticular | 0.02 | 1 |
| | (2) | lens sheet | 0.04 | 5 |
| | (3) | | 0.06 | 9 |
| | (4) | | 0.1 | 20 |
| | (5) | | 2.0 | 300 |

As can be seen from Table 1, according to the coating applicator of the Example, the silicone oil can be applied at a thickness less than that in conventional cases.

(2) Packing Test

One hundred sheets of each of the optical sheets (the Fresnel lens sheets or the lenticular lens sheets) to which the silicone oil was applied in Test Examples 1(3), 1(4), 2(2), and 2(4) were stacked alternately with foamed polyethylene sheets having a thickness of 1 mm, and a box packed with a poly-laminated paper sheet and a polyethylene sheet was produced. The box was left to stand in an environment with a temperature of 20° C. for 30 days and was subsequently unpacked. Then, the thickness of the silicone oil adhering to the optical sheets was measured. The results are shown in Table 2.

TABLE 2

| | | | Thickness of silicone | |
|---|---|---|---|---|
| | | Ra of | oil (nm) | |
| | | surface of | Immediately | 30 days |
| | Coating | transfer | after | after |
| | surface | roller (μm) | manufacture | packing |
| Test Example | Fresnel | 0.2 | 10 | 2 |
| 1 (3) | lens | | | |
| Test Example | Fresnel | 0.3 | 20 | 13 |
| 1 (4) | lens | | | |
| Test Example | Lenticular | 0.04 | 5 | 1.5 |
| 2 (2) | lens | | | |
| Test Example | Lenticular | 0.1 | 20 | 12 |
| 2 (4) | lens | | | |

As can be seen from Table 2, even when the coating thickness of the silicone oil was 10 nm or less, the thickness of the adhering silicone oil was several nm after the packing test. Therefore, a certain amount of the coating thickness can be ensured even when the transfer of the silicone oil to a packing material occurs.

(3) Packing Transportation Test

One hundred sheets of each of the Fresnel lens sheet (silicone oil coating thickness: 0.3 nm) of Test Example 1(1), the Fresnel lens sheet (silicone oil coating thickness: 10 nm) of Test Example 1(3), the Fresnel lens sheet (silicone oil coating thickness: 20 nm) of Test Example 1(4), the Fresnel lens sheet (silicone oil coating thickness: 200 nm) of Test Example 1(6), the lenticular lens sheet (silicone oil coating thickness: 1 nm) of Test Example 2(1), the lenticular lens sheet (silicone oil coating thickness 5 nm) of Test Example 2(2), the lenticular lens sheet (silicone oil coating thickness: 20 nm) of Test Example 2(4), the lenticular lens sheet (silicone oil coating thickness: 300 nm) of Test Example 2(5), the Fresnel lens sheet to which the silicone oil was not applied, and the lenticular lens sheet to which the silicone oil was not applied were stacked alternately with foamed polyethylene sheets having a thickness of 1 mm. Then, a box packed with a poly-laminated paper sheet and a polyethylene sheet was produced. The box was loaded onto a 1-ton truck, and the truck traveled 1000 km, whereby a transportation test was performed.

The package was unpacked after the transportation, and the appearance of each of the lenticular lens sheets or the Fresnel lens sheets was inspected by randomly selected 10 observers. Furthermore, the silicone oil-applied Fresnel lens sheet of each of the Test Examples was combined with the lenticular lens sheet to which the silicone oil was not applied, and the silicone oil-applied lenticular lens sheet of each of the Test Examples was combined with the Fresnel lens sheet to which the silicone oil was not applied. For each case, the lens sheets were arranged such that the lens surfaces thereof were opposed to each other, and the periphery thereof was secured with adhesive tape, whereby a transmission type screen was produced. Similarly, another transmission type screen was produced from the Fresnel lens sheet to which the silicone oil was not applied and the lenticular lens sheet to which the silicone oil was not applied. Each of the obtained transmission type screens was attached to a rear projection type display device (a projection TV “SVP-47W”, product of SAMSUNG), and the image on the display device was evaluated.

The appearance of each of the sheets was evaluated by visually observing the presence or absence of problems in a room with a brightness of about 500 lux. The image evaluation was performed by visually evaluating a display when a TV image and an all-white signal were displayed on the rear projection type display device in a dark room, and the presence or absence of problems was determined. The results are shown in Table 3.

(4) Mounted Transportation Test

For each of the Fresnel lens sheet (silicone oil coating thickness: 0.3 nm) of Test Example 1(1), the Fresnel lens sheet (silicone oil coating thickness: 10 nm) of Test Example 1(3), the Fresnel lens sheet (silicone oil coating thickness: 20 nm) of Test Example 1(4), the Fresnel lens sheet (silicone oil coating thickness: 200 nm) of Test Example 1(6), the lenticular lens sheet (silicone oil coating thickness: 1 nm) of Test Example 2(1), the lenticular lens sheet (silicone oil coating thickness: 5 nm) of Test Example 2(2), the lenticular lens sheet (silicone oil coating thickness: 20 nm) of Test Example 2(4), and the lenticular lens sheet (silicone oil coating thickness: 300 nm) of Test Example 2(5), the silicone oil-applied Fresnel lens sheet was combined with the lenticular lens sheet to which the silicone oil was not applied, and the silicone oil-applied lenticular lens sheet was combined with the Fresnel lens sheet to which the silicone oil was not applied. For each case, the lens sheets were arranged such that the lens surfaces thereof were opposed to each other, and the periphery thereof was secured with adhesive tape, whereby a transmission type screen was produced. Similarly, another transmission type screen was produced from the Fresnel lens sheet to which the silicone oil was not applied and the lenticular lens sheet to which the silicone oil was not applied. Each of the obtained transmission type screens was attached to a rear projection type display device (a projection TV “SVP-47W”, product of SAMSUNG), whereby a rear projection type display device was produced. Each of the obtained rear projection type display devices was packed and loaded onto a 1-ton truck, and the truck traveled 1000 km, whereby the mounted transportation test was performed.

The package of each of the rear projection type display devices was unpacked after the transportation. As in the evaluation of the Packing transportation test of (3) above, the appearance of each of the transmission type screens and unevenness in brightness when an image was projected were evaluated. The results are shown in Table 3.

TABLE 3

| | Optical sheet | | Packing transport test | | Mounted transportation test | |
|---|---|---|---|---|---|---|
| | | Coating thickness | Evaluation of | | Evaluation of | |
| | Test | of silicone oil | appearance of | | appearance of | |
| | Example | (nm) | optical sheet | Image evaluation | screen | Image evaluation |
| Example | 1 (1) | Fresnel lens | Good | Good | Good | Good |
| 1-1 | | sheet 0.3 nm | | | | |
| Example | 1 (3) | Fresnel lens | Good | Good | Good | Good |
| 1-2 | | sheet 10 nm | | | | |
| Example | 2 (1) | Lenticular lens | Good | Good | Good | Good |
| 2-1 | | sheet 1 nm | | | | |
| Example | 2 (2) | Lenticular lens | Good | Good | Good | Good |
| 2-2 | | sheet 5 nm | | | | |
| Comp. Ex. | 1 (4) | Fresnel lens | Wrinkle-like | Poor; brightness | Good | Poor; brightness unevenness |
| 1-1 | | sheet 20 nm | streak pattern | unevenness was found in | | was found, or only central |
| | | | was observed to | wrinkle-like streak | | portion was brighter, as |
| | | | some extent | pattern portion | | viewed obliquely from above |
| Comp. Ex. | 1 (6) | Fresnel lens | Wrinkle-like | Poor; brightness | Good | Poor; brightness unevenness |
| 1-2 | | sheet 200 nm | streak pattern | unevenness was found in | | was found, or only central |
| | | | was observed to | wrinkle-like streak | | portion was brighter, as |
| | | | some extent | pattern portion | | viewed obliquely from above |
| Comp. Ex. | 2 (4) | Lenticular lens | Wrinkle-like | Poor; brightness | Good | Poor; vertical streak-like |
| 2-1 | | sheet 20 nm | streak pattern | unevenness was found in | | brightness unevenness was |
| | | | was observed to | wrinkle-like streak | | found, as viewed obliquely |
| | | | some extent | pattern portion | | from right or left side |
| Comp. Ex. | 2 (5) | Lenticular lens | Wrinkle-like | Poor; brightness | Good | Poor; vertical streak-like |
| 2-2 | | sheet 300 nm | streak pattern | unevenness was found in | | brightness unevenness was |
| | | | was observed to | wrinkle-like streak | | found, as viewed obliquely |
| | | | some extent | pattern portion | | from right or left side |
| Comp. | | Fresnel lens | Good | Good | Poor; cloudy | Poor; cloudy portion was |
| Ex. 3-1 | | sheet | | | portion was | observed as dark shadow |
| | | (no coating) | | | found around | |
| | | | | | frame | |
| Comp. | | Lenticular lens | Good | Good | Poor; cloudy | Poor; cloudy portion was |
| Ex. 3-2 | | sheet | | | portion was | observed as dark shadow |
| | | (no coating) | | | found around | |
| | | | | | frame | |

As can be seen from Table 3, for the optical sheet and the transmission type screen of each of Examples 1-1 and 1-2 and Examples 2-1 and 2-2 to which the silicone oil was applied at a thickness of 0.3 to 10 nm by means of the coating applicator of the present invention, all the ten observers judged that no problems were found in the appearance in both the packing transportation test and the mounted transportation test. Furthermore, when an image was displayed, unevenness in brightness was not found, and thus all the ten observers judged that no problems were found.

Meanwhile, for Comparative Examples 1-1 and 1-2, all the ten observers judged that a wrinkle-like streak pattern was noticeable in the image evaluation of the packing transportation test and that a problem was present. Furthermore, in the image evaluation of the mounted transportation test, a remarkably bright portion was found in only a region having a diameter of approximately 20 mm and positioned around the central portion when the image was observed obliquely from above, and all the ten observers judged that a problem of luminance unevenness was present.

For Comparative Examples 2-1 and 2-2, all the ten observers judged that a winkle-like streak pattern was noticeable in the image evaluation of the packing transportation test and that a problem was present. Furthermore, in the image evaluation of the mounted transportation test, when the image was observed obliquely from the right side and/or the left side, vertical streak-like brightness unevenness was found at random intervals of several tens of mm, and all the ten observers judged that a problem was present.

For Comparative Examples 3-1 and 3-2, no problems were found in the packing transportation test. However, in the appearance evaluation in the mounted transportation test, a rubbed and clouded portion was found around the frame, i.e., the region within 50 mm from the periphery, and all the ten observers judged that a problem was present in the appearance. Furthermore, in the image evaluation, the clouded portion was observed as a dark shadow and was noticeable even when viewed from any angles, and all the ten observers judged that a problem was present.

Furthermore, the transmission type screen of each of Comparative Examples 3-1 and 3-2 was removed from the rear transmission type display device, and the surface of the Fresnel lens sheet was observed. Then, it was found that the lens edge portion of the Fresnel lens was ground in the clouded portion.

As described above, according to the transmission type screen of the present invention, the generation of stray light caused by the presence of the friction-reducing agent can be prevented. Furthermore, the occurrence of a wrinkle-like pattern generated when the optical sheets constituting the transmission type screen are stacked with a cushion material or the like therebetween can be prevented. In addition to this, when the transmission type screens are attached to the rear projection type display devices and are transported, a problem caused by rubbing of the transmission type screens against each other can be resolved.

The transmission type screen of the present invention is useful in rear projection type display devices such as rear projection type televisions.

In addition to this, the coating applicator of the present invention is useful as an applicator for applying a coating liquid such as a friction-reducing agent to an optical sheet such as a Fresnel lens sheet or a lenticular lens sheet at a thickness of 0.3 to 100 nm, which is less than a conventional thickness.

What is claimed is:

1. An optical device comprising a combination of a plurality of optical sheets, wherein a friction-reducing agent is provided on a surface of at least one of the optical sheets to a thickness of 0.3 nm or more and 10 nm or less.

2. The optical device according to claim 1, wherein the optical device is a transmission type screen.

3. The optical device according to claim 1 or 2, wherein the thickness of the friction-reducing agent is 0.5 nm or more and 6 nm or less.

4. The optical device according to claim 1, wherein the optical sheets are selected from the group consisting of a Fresnel lens sheet, a lenticular lens sheet, a prism sheet, a microlens sheet and a light-diffusion sheet.

5. The optical device according to claim 2, wherein the optical sheets comprise a lenticular lens sheet and a Fresnel lens sheet, and the friction-reducing agent is provided to at least one of opposed surfaces of these lens sheets.

6. A method for manufacturing the optical device according to claim 1, comprising applying the friction-reducing agent to at least one surface of the plurality of optical sheets constituting the optical device at a thickness of 0.3 nm or more and 10 nm or less.

7. The method according to claim 6, wherein the optical device is a transmission type screen.

8. A coating applicator comprising: a transfer roller; coating liquid-supplying means for supplying a coating liquid to the transfer roller; and scraping means for adjusting a thickness of the coating liquid adhering to the transfer roller, wherein a surface roughness Ra (JIS B 0601-1982) of the transfer roller is 0.01 to 1 μm.

9. The coating applicator according to claim 8, wherein an object to be coated is applied to have a coating with a thickness of 0.3 to 100 nm.

10. The coating applicator according to claim 8, wherein a surface roughness of the transfer roller is changed depending on a position on the transfer roller.

11. The coating applicator according to claim 8, comprising a rubber-made coating roller for transferring the coating liquid from the transfer roller to an object to be coated.

12. The coating applicator according to claim 11, wherein a relative speed of rotation between the transfer roller and the coating roller is adjustable.

13. The coating applicator according to claim 11, wherein a relative speed between the transfer roller or the coating roller and the object to be coated is adjustable.
